(19) United States
(12) Patent Application Publication
(10) Pub. No.: US 2009/0097119 A1
(43) Pub. Date: Apr. 16, 2009

(54) DIFFRACTION MICRO FLOW STRUCTURE AND OPTICAL TWEEZERS USING THE SAME

(75) Inventors: Chen Peng, Taipei City (TW); William Wang, Taoyuan County (TW); Chung-Cheng Chou, Taoyuan County (TW); Fung-Hsu Wu, Taoyuan City (TW); Long Hsu, Hsinchu City (TW); Cheng-Hsien Liu, Hsinchu City (TW); Sheng-Yang Tseng, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DAXON TECHNOLOGY INC., Taoyuan County (TW)

(21) Appl. No.: 12/143,943

(22) Filed: Jun. 23, 2008

(30) Foreign Application Priority Data
Oct. 15, 2007 (TW) 96138484

(51) Int. Cl. G02B 27/42

(52) U.S. Cl. 359/558

(57) ABSTRACT

A diffraction micro flow structure and optical tweezers using the same are provided. The diffraction micro flow structure comprises a substrate and a diffraction part. The substrate comprises at least a flow path. The diffraction part is disposed on the substrate. The diffraction part comprises a diffraction optical element. After light passes through the diffraction optical element, the light is focused in the flow path and forms an optical field.

This application claims the benefit of Taiwan application Serial No. 96138484, filed Oct. 15, 2007, the subject matter of which is incorporated herein by reference.

### BACKGROUND OF THE INVENTION

The present invention relates to a diffraction micro flow structure and an optical tweezer using the same. More specifically, the present invention relates to a diffraction micro flow structure having a diffraction optical element (DOE) placed on a substrate and an optical tweezer using the same.

As technology progresses, micro- and nano-particles have been widely utilized in MEMS, biotechnology, and medical industries. Currently, movements of particles can be done via direct contact by micro tweezers mechanically; however, particles may be damaged this way. To avoid damage to particles, non-contact and non-intrusive optical tweezers using optical elements and laser lights are developed to be used to control micro- and nano-particles. Typically, an optical tweezer device forms an optical field by having a laser light passing through a diffraction optical element and being focused by a lens. The diffraction optical element is for controlling the optical pressure potential gradient of the optical field of the laser light to control a particle's movement in a micro flow structure.

Biochips are devices minimized using MEMS technology. It can be applied in various fields when combined with optical systems, MEMS, micro fluids, and biotechnologies. It is often used in biochemical processes, analysis, testing, drug development, and environmental detections. Biochips can be used to examine bio particles such as cells or microorganisms in a micro flow structure through optical systems. However, when to achieve controlling the bio particles in the micro channels, a new optical tweezer device, which is formed by the original with diffraction optical elements, is needed.

### SUMMARY OF THE INVENTION

The present invention relates to a micro flow structure and an optical tweezer using the same. The micro flow structure comprises a diffraction optical element placed on a substrate for the micro flow structure to diffract a laser light.

The present invention discloses a diffraction micro flow structure comprising a substrate and a diffraction part. The substrate has at least one flow path. The diffraction part is located on the substrate and includes a diffraction optical element. When a light is passed through the diffraction optical element, it is focused in the flow path to form an optical field.

The present invention further discloses an optical tweezer comprising a light source, a micro flow structure, and an object lens assembly. The micro flow structure includes a substrate and a diffraction part. The light source is for producing a light beam. The substrate has at least one flow path, and the diffraction part is located on the substrate and includes a diffraction optical element. The object lens assembly comprises an object lens, and the object lens has a focus surface in the flow path. When the light beam is passed through the diffraction optical element and the object lens, it is focused on the focus surface to form an optical field.

### BRIEF DESCRIPTION OF THE DRAWINGS

FIG. 1 is an exemplary micro flow structure in accordance with an embodiment of the present invention.

FIG. 2 is an exemplary micro flow structure having two diffraction optical elements on the same side of a substrate in accordance with an embodiment of the present invention.

FIG. 3 is an exemplary micro flow structure having one diffraction optical element on either side of a substrate in accordance with an embodiment of the present invention.

FIG. 4 is an exemplary optical tweezer in accordance with an embodiment of the present invention.

FIG. 5 depicts the top view of a micro flow structure being a round disc.

FIG. 6 is an exemplary micro flow structure of another embodiment of the present invention.

FIG. 7 depicts a micro flow structure having two reflective layers in accordance with an embodiment of the present invention.

FIG. 8 depicts a micro flow structure having two inclined incident lights in accordance with an embodiment of the present invention.

FIG. 9 depicts an exemplary micro flow structure having a reflective diffraction optical element in accordance with an embodiment of the present invention.

FIG. 10 is an exemplary optical tweezer in accordance with an embodiment of the present invention.

FIG. 11 is an exemplary optical tweezer in accordance with an embodiment of the present invention.

FIG. 12 depicts the top view of a micro flow structure having four diffraction optical elements.

### DETAIL DESCRIPTION OF THE INVENTION

The present invention discloses a micro flow structure comprising a substrate and a diffraction part. The micro flow structure can be applied to biochips or optical discs. The substrate has at least one flow path. The diffraction part is placed on the substrate and includes a diffraction optical element. When an incident light is passed through the diffraction optical element, it is focused in the flow path to form an optical field. The flow path is for holding a solution having several particles. Several embodiments are described below to explain the micro flow structure and an optical tweezer using the same. In the drawings, lights before diffraction are represented in solid lines, lights after diffraction are represented in dotted lines, and traveling directions of the lights are represented by arrows.

### First Embodiment

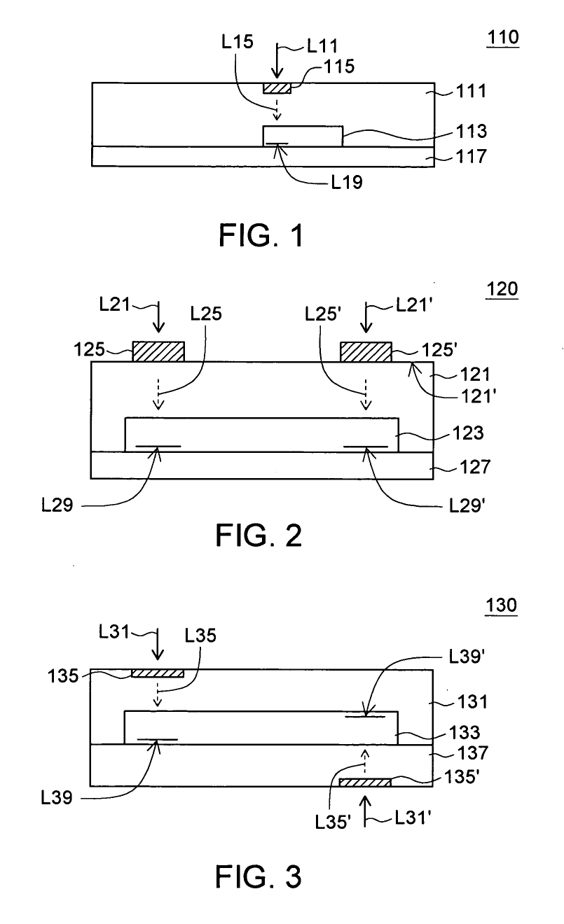

Referring to FIG. 1, FIG. 1 depicts a micro flow structure of the present invention in accordance with the first embodiment. The micro flow structure 110 comprises a substrate 111 and a diffraction part. The substrate 111 has a flow path 113. The diffraction part includes a diffraction optical element 115. The diffraction optical element 115 is placed on the substrate 111 and on the flow path 113. An incident light L11 passes through the diffraction optical element 115 and becomes a diffracted light L15. The diffracted light L15 forms an optical field L19 in the flow path 113. The shape of the optical field L19 depends on the design of the diffraction optical element 115, and in the current embodiment, the optical field L19 is a linear optical field.

The micro flow structure is manufactured by forming the substrate 111 using a press mold having a flow path structure and a diffractive shape, or by injection molding. The subsequently formed substrate 111 then comprises the flow path 113 and the diffraction optical element 115. Then, attach a base 117 to the substrate 111 so the flow path 113 can have the capacity to hold solutions. Also, the incident light L11 can form the optical field L19 after passing through the diffraction optical element 115 that is in the flow path 113.

Referring to FIG. 2, FIG. 2 depicts the micro flow structure having two diffraction optical elements located on the same side of the substrate. The diffraction part of the micro flow structure 120 includes two diffraction optical elements, and two optical fields are formed in the flow path after laser lights are passed through the diffraction part.

The micro flow structure 120 comprises a substrate 121 and a diffraction part. The substrate 121 has a flow path 123 and the diffraction part has diffraction optical elements 125 and 125′. The diffraction optical elements 125 and 125′ are placed next to each other on the surface 121′ of the substrate 121. The shapes of the diffraction optical element 125 and the diffraction optical element 125′ may be the same or different.

An incident light L21 passes through the micro flow structure 120 and the diffraction optical element 125. The diffracted light L25 forms an optical field L29 in the flow path 123. Another incident light L21′ passes through the micro flow structure 120 and the diffraction optical element 125′. The diffracted light L25′ forms another optical field L29′ in the flow path 123. The shapes of the optical fields L29 and L29′ depend on the shape of the diffraction optical element 125 and 125′ respectively.

The micro flow structure 120 having the flow path 123 can be formed by combining substrates manufactured by an optical disc manufacturing process, or by laser inscribing techniques. By attaching the substrate 121 and base 127 together, the flow path 123 is able to hold solutions. Glues are put on the flow path 123 of the substrate 121 corresponding to the locations where the diffraction optical elements 125 and 125′ should be, and the diffraction optical elements 125 and 125′ are formed by pressing a press having diffraction shapes to the substrate 121. The diffraction optical elements 125 and 125′ are fixed to the flow path 123 via the glues. The micro flow structure 120 can also be a biochip formed by an optical disc manufacturing process.

The micro flow structure 120 forms two optical fields L29 and L29′ in the flow path 123 when two incident lights L21 and L21′ are passed through. Depending on the designs of the diffraction optical elements, shapes, intensities, and locations in the flow path 123 of the optical fields L29 and L29′ in the flow path 123 can be the same or different.

Referring to FIG. 3, FIG. 3 depicts a micro flow structure 130 having one diffraction optical element on either side of the substrate. The micro flow structure has a diffraction part having two diffraction optical elements, one on each side of the flow path 133.

The micro flow structure 130 comprises a substrate 131, a base 137, and a diffraction part. The substrate 131 has a flow path 133 and the diffraction part includes diffraction optical elements 135 and 135′. The diffraction optical element 135 is located on the substrate 131 and above the flow path 133. The diffraction optical element 135′ is located on the substrate 131 and below the flow path 133. The flow path 133 is located in between the diffraction optical element 135 and the diffraction optical element 135′.

An incident light L31 passes through the diffraction optical element 135 and becomes a diffracted light L35. The diffracted light L35 then forms an optical field L39 in the flow path 133. Another incident light L31′ passes through the micro flow structure 130 and the diffraction optical element 135′ in a reverse direction of the incident light L31 and becomes diffracted light L35′. The diffracted light L35′ forms an optical field L39′ in the flow path 133. The shapes of the optical fields L39 and L39′ depend on the designs of the diffraction optical elements 135 and 135′.

Through the diffraction optical element 135 above the flow path 133 and the diffraction optical element 135′ below the flow path 133, the incident light L31 and the incident light L31′ form two optical fields L39 and L39′ in the micro flow structure 130.

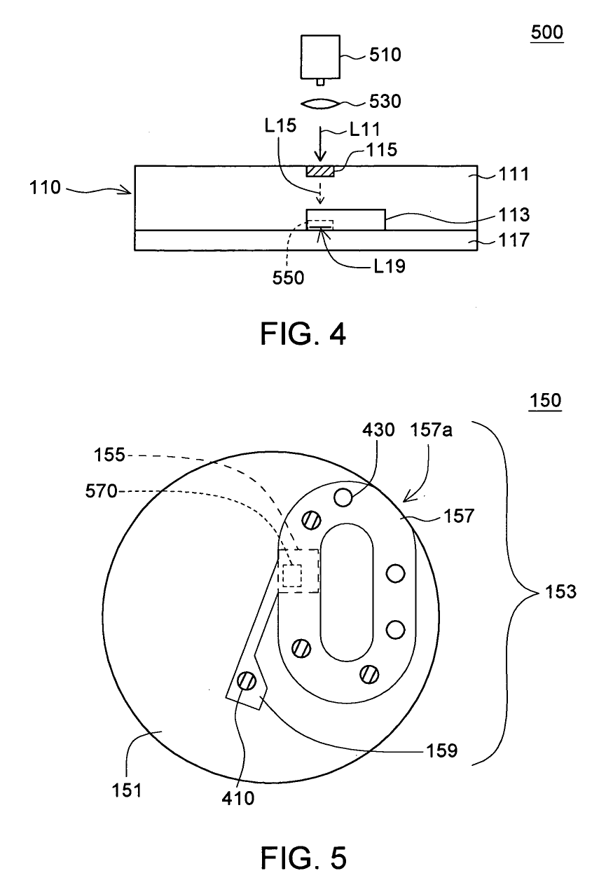

Referring to FIG. 4, FIG. 4 depicts an optical tweezer 500 in accordance with the first embodiment of the present invention. The optical tweezer is for controlling particles when used with the micro flow structure disclosed in this embodiment. The micro flow structure 110 is used for explanation here.

The optical tweezer 500 comprises a light source 510, the micro flow structure 110, and an object lens assembly. The light source 510 is for outputting a light beam. The object lens assembly includes at least an object lens 530, and the object lens 530 has a focus surface in the flow path 113. When the light beam is passed through the object lens 530 and the diffraction optical element 115, the light beam is focused on the focus surface and forms the optical field L19.

The light source 510 can be a laser light source, for outputting a laser beam. An incident light L11 is formed when the laser beam outputted from the light source 510 is passed through the object lens 530. When the incident light L11 is passed through the diffraction optical element 115 and becomes a diffracted light L15, the optical field L19 is formed in a optical field zone 550 in the flow path 113. The area of the optical field zone 550 depends on the design of the diffraction optical element 115 and the focus surface of the object lens 530.

This embodiment explains that the optical tweezer 500 can form the optical field L19 in the optical field zone 550 with the micro flow structure 110 via the light source 510 and the object lens 530. Therefore, an optical field can be formed in a flow path by adding a light source and an object lens to the micro flow structure 110. This is rather convenient for a user.

Referring to FIG. 5, FIG. 5 depicts the top view of a disc shape micro flow structure. The micro flow structure 150 comprises a substrate 151 and a diffraction part. The substrate 151 has a flow path 153, and the diffraction part has a diffraction optical element 155. The diffraction optical element 155, similar to the diffraction optical element 135′ (FIG. 3) of the micro flow structure 130, is located below the flow path 153. The flow path 153 has a circulation area 157 and a storage area 159. The circulation area 157 has an opening 157a. A micro pump (not shown) is located at the opening 157a to circulate solution in the circulation area 157.

A solution with micro particles 410 and 430 flows in the circulation area 157 and is waiting to be tested. The micro pump at the opening 157a pumps the particles 410 and 430 to flow in the circulation area 157. An incident light (not shown) is passed through the diffraction optical element 155 to form an optical field (not shown) in an optical field zone 570. The particle 410 flows into the optical field zone 570 and is captured and isolated into the storage area 159 by the optical field. When the particle 430 flows into the optical field zone 570, whether the particle 430 is captured into the storage area 159 or isolated to be circulated in the circulation area 157 is determined by the characteristics of the particle 430. Separation of specific particles in a solution can be achieved.

In the micro flow structure and the optical tweezer using the same of the first embodiment of the present invention, the diffraction part is located on the substrate, so the micro flow structure can diffract incident light directly to form an optical field in the flow path. The micro flow structure can be used in an optical disc or a biochip. The micro flow structure can control micro- and nano-particles in the flow path when combined with an optical tweezer having a light source and an object lens, no other complex optical elements are required.

### Second Embodiment

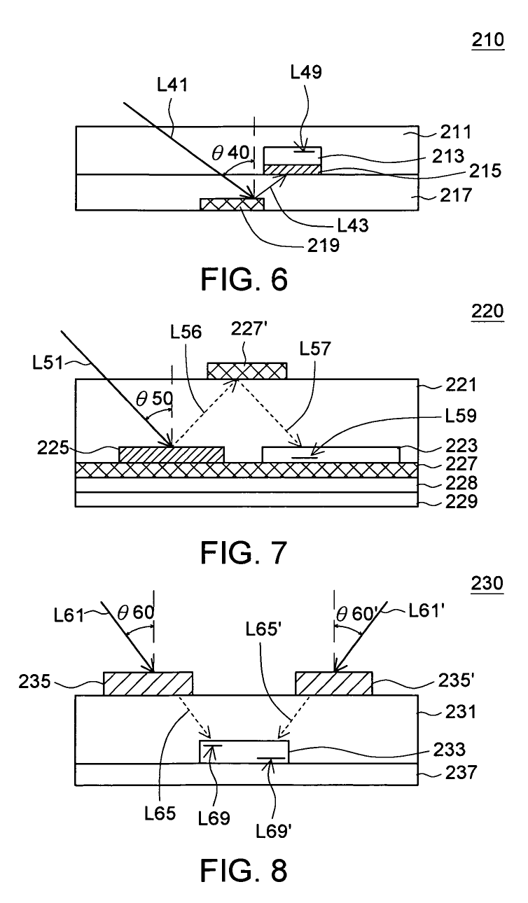

Second embodiment of the present invention discloses a micro flow structure having a diffraction optical element and a flow path located next to each other. Referring to FIG. 6, FIG. 6 is an exemplary micro flow structure in accordance with the second embodiment of the present invention. The micro flow structure 210 comprises a substrate 211, a base 217, a diffraction part, and a reflective part. The substrate 211 comprises a flow path 213. The diffraction part comprises a diffraction optical element 215, which is located in the substrate 211 and next to the flow path 213. The reflective part comprises a reflection layer 219, which is located next to a side of the diffraction optical element 215 and on the base 217. The diffraction optical element 215 is located on the substrate 211 and between the flow path 213 and the reflection layer 219. An incident light L41 enters the micro flow structure 210 at an incident angle θ 40. The incident light L41 is reflected by the reflection layer 219 and becomes a reflected light L43. The reflected light L43 passes through the diffraction optical element 215 and becomes a diffracted light (not shown). The diffracted light forms an optical field L49 in the flow path 213. The reflection layer 219 is for reflecting the incident light L41 before being diffracted.

Referring to FIG. 7, FIG. 7 depicts a micro flow structure having two reflection layers. The micro flow structure 220 comprises a substrate 221, a diffraction part, and a reflection part. The substrate 221 comprises a flow path 223 and the diffraction part comprises a diffraction optical element 225. The flow path 223 and the diffraction optical element 225 are located next to each other and at the same height. The reflection part comprises two reflection layers 227 and 227′. The reflection layer 227 is on one side of the diffraction optical element 225, and the reflection layer 227′ is on another side of the diffraction optical element 225, so the diffraction optical element 225 is located between the reflection layer 227 and the reflection layer 227′. The reflection layer 227 is attached to the substrate 221. An incident light L51 enters the micro flow structure 220 at an incident angle θ 50. After passing through the diffraction optical element 225 and the reflection layer 227, the incident light L51 becomes a diffracted reflection light L56. The diffracted reflection light L56 then passes through the reflection layer 227′ to become another diffracted reflection light L57. The diffracted reflection light L57 forms an optical field L59 in the flow path 223. The reflection layer 227′ can also be a reflective diffraction optical element, the diffraction optical element 225 can be a reflection layer, and the reflection layer 227 can be removed. The incident light L51 can still become the diffracted reflection light L57 and form the optical field 59 in the flow path 223 with the aforementioned changes.

The substrate 221 of micro flow structure 220 can be a chip having a flow path 223, such as a biochip or a bio-disc. The diffraction optical element 225 can be made by pressing a press having a diffraction shape to the substrate 221. The substrate 221 can also be made by injection molding. After the flow path 223 and the diffraction 225 are formed, the reflection layers 227 and 227′ can be attached to the substrate 221 directly by sputtering. The reflection layer 227 can also be attached to the substrate 221 and a base 229 via using an adhering layer 228.

The incident light L51 is reflected to the flow path 223 in the micro flow structure 220 by the reflection layers 227 and 227′, and forms the optical field L59 in the flow path 223. Reflection layers 227 and 227′ reflect the light that has been diffracted.

Referring to FIG. 8, FIG. 8 depicts a micro flow structure having two inclined incident lights. The micro flow structure comprises two diffraction optical elements located next to a flow path.

The micro flow structure 230 comprises a substrate 231, a base 237, and a diffraction part. The substrate 231 comprises a flow path 233. The flow path 233 is able to hold solutions when the substrate 231 and the base 237 are attached together. The diffraction part comprises diffraction optical elements 235 and 235′, which are located next to and one on each side of the flow path 233. The diffraction optical elements 235 and 235′ can be of the same or different heights on the substrate 231. Incident lights L61 and L61′ enter the micro flow structure 230 at incident angles θ 60 and θ 60′ respectively, and pass through diffraction optical elements 235 and 235′ respectively to become diffracted lights L65 and L65′. The diffracted lights L65 and L65′ form optical fields L69 and L69′ in the flow path 233. The optical fields L69 and L69′ may have the same or different shapes and intensities in the flow path 233.

The incident lights L61 and L61′ are diffracted by the diffraction optical elements 235 and 235′ respectively to enter the micro flow structure 230 in inclined angles, and form the optical fields L69 and L69′ in the flow path 233.

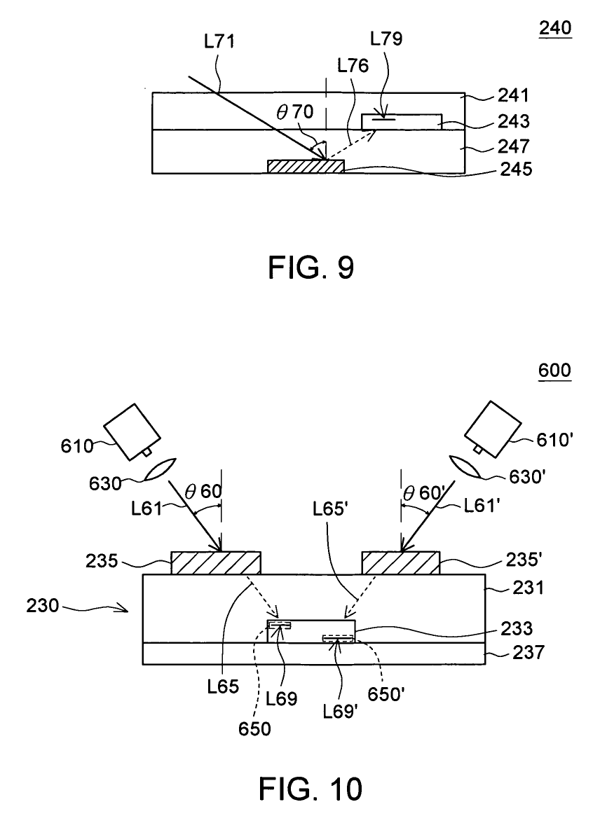

Diffraction optical elements in a micro flow structure can be reflective diffraction optical elements. Referring to FIG. 9, FIG. 9 depicts a micro flow structure 240 having a reflective diffraction optical element.

The micro flow structure 240 comprises a substrate 241, a base 247, and a diffraction part. The substrate 241 comprises a flow path 243. The diffraction part comprises a diffraction optical element 245, which is located on the substrate 247 and next to the flow path 243. The diffraction optical element 245 is a reflective diffraction optical element. The diffraction optical element 245 is for diffracting and reflecting an incident light L71. The incident light L71 enters the micro flow structure 240 at an incident angle θ 70. The incident light L71 becomes a diffracted reflection light L76 after passing through the diffraction optical element 245, and the diffracted reflection light L76 forms an optical field L79 in the flow path 243.

The micro flow structure 240 uses a reflective diffraction optical element to form the diffracted reflection light L76 after the incident light L71 passes through the diffraction optical element 245, and form the optical field L79 in the flow path 243.

Referring to FIG. 10, FIG. 10 is an exemplary optical tweezer in accordance with the second embodiment of the present invention. The optical tweezer can be combined in use with any of the above-mentioned micro flow structures to control micro- and nano-particles. The micro structure 230 is used for detail description here.

The optical tweezer 600 comprises light sources 610 and 610′, the micro flow structure 230, and an object lens assembly. The light sources 610 and 610′ each outputs a light beam. The object lens assembly comprises object lenses 630 and 630′, and the focus surfaces of object lenses 630 and 630′ are in the flow path 233. When the light beam outputted by the light source 610 passes through the object lens 630 and the diffraction optical element 235, it is focused on its focus surface to form the optical field L69. When the light beam outputted by the light source 610′ passes through the object lens 630′ and the diffraction optical element 235′, it is focused on its focus surface to form the optical field L69′.

The light beam outputted from the light source 610 passes through the object lens 630 to become the incident light L61. The incident light L61 passes through the diffraction optical element 235 to become the diffracted light L65 and focuses in an optical field zone 650 of the flow path 233 to form the optical field L69. The optical field zone 650 depends on the design of the diffraction optical element 235 and the focus surface of the object lens 630. Similarly, the light beam outputted from the light source 610′ passes through the object lens 630′ to become the incident light L61′. The incident light L61′ passes through the diffraction optical element 235′ to become the diffracted light L65′ and focuses in an optical field zone 650′ of the flow path 233 to form the optical field L69′. The optical field zone 650′ depends on the design of the diffraction optical element 235′ and the focus surface of the object lens 630′. Locations of shapes and intensities of the optical fields L69 and L69′ can be the same or different. The focus surfaces of object lenses 630 and 630′ in the flow path 233 can be the same or different. This way, micro flow structure 230 can control two types of micro- and nano-particles via the light sources 610 and 610′, and the diffraction optical elements 235 and 235′ at the same time.

The optical tweezer 600 of the present embodiment utilizes the light sources 610 and 610′ and object lenses 630 and 630′ to work with the micro flow structure 230 to form in the optical field zones 650 and 650′ the two different types of optical fields L69 and L69′ respectively, and to control two different types of particles.

The second embodiment of the present invention discloses a micro flow structure and an optical tweezer using the same. The micro flow structure comprises diffraction optical elements that are located next to the flow path, so the micro flow structure forms the optical fields in the optical field zones of the flow path. Also, the micro flow structure further comprises a reflection part, having at least one reflective layer. The reflective layer reflects incident lights before or after the incident lights are diffracted. The reflective layer is for changing the direction of the incident lights so that it forms an optical field in the flow path. The micro flow structure can be applied in an optical disc or a biochip. An optical disc or a biochip having a micro flow structure can be used to control particles in a flow path by adding an optical tweezer with a light source and an object lens.

### Third Embodiment

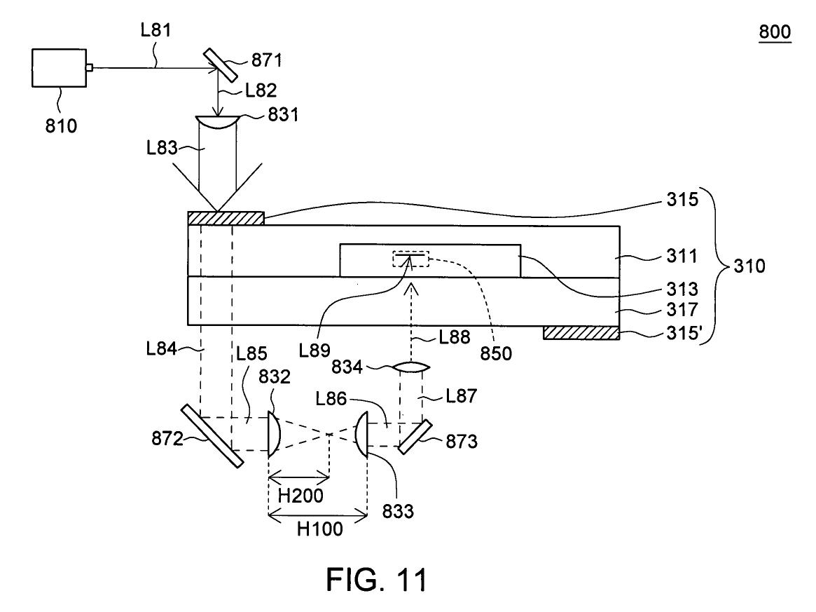

Referring to FIG. 11, FIG. 11 shows an exemplary optical tweezer in accordance with the third embodiment of the present invention. An optical tweezer 800 comprises a light source 810, a micro flow structure 310, an object lens assembly, and a reflection assembly. The micro flow structure 310 comprises a substrate 311, a base 317, and a diffraction part. The substrate 311 comprises a flow path 313 and the diffraction part comprises diffraction optical elements 315 and 315′. The diffraction optical elements 315 and 315′ and the flow path 313 are located next to each other and on the substrate 311 and base 317. The object lens assembly comprises object lenses 831, 832, 833, and 834, and the reflection assembly comprises reflection mirrors 871, 872, and 873.

The light source 810 provides an incident light L81. The incident light L81 is reflected by the reflection mirror 871 and becomes a reflected light L82. The reflected light L82 is perpendicular to the micro flow structure 310 and passes through the object lens 831. The reflected light L82 is expanded in width after passing through the object lens to become an expanded light L83. The expanded light L83 passes through the diffraction optical element 315 and becomes a diffracted light L84. The diffracted light L84 passes through the substrate 311 and is reflected by reflection mirror 872 to become a diffracted reflective light L85. The reflection mirror changes the direction of the diffracted light L84 so the diffracted reflective light L85 is parallel to the micro flow structure 310. The diffracted reflective light L85 passes through the object lenses 832 and 833 to become a diffracted reflective light L86. The distance between the object lens 832 and the object lens 833 is H100, which is greater than H200, the focusing distance of the object lens 832. Therefore, the width of the diffracted reflective light L85 is changed by the object lenses 832 and 833 to become the diffracted reflective light L86. The diffracted reflective light L86 is reflected by reflection mirror 873 and becomes a diffracted reflective light L87. The diffracted reflective light L87 is perpendicular to the micro flow structure 310 and passes through the object lens 834 to form a diffracted focus light L88. The focus surface of the object lens 834 is in the flow path 313 and the diffracted focus light L88 forms an optical field L89 in an optical field zone 850 in the flow path 313. The shape of the optical field L89 depends on the design of the diffraction optical element 315. Here, we take the optical field L89 to be a linear optical field. The optical field L89 is formed in the focus surface of the object lens 834 and is for controlling a particular particle (not shown) in a solution.

Also, the optical tweezer 800 further comprises a testing unit (not shown), the testing unit is located next to the flow path 310 for testing a plurality of particles. The testing unit may be an image sensor device, a photoelectric sensor, an electrical sensor, a magnetic sensor, or a combination thereof. The testing unit can detect changes in the particles, or can adjust the optical field L89 according to the types of the particles.

The optical tweezer 800 changes the incident light via the object lens assembly and the reflection assembly. The reflection mirror 871 reflects the incident light L81 before being diffracted, and the reflection mirrors 872 and 873 reflect the incident light L81 after being diffracted. The object lens assembly is for controlling the width of the incident light L81 so the incident light L81 will form an appropriate diffraction light after passing through the diffraction optical element 315, and ultimately form an optical field L89 in the flow path 313. Also, the optical tweezer may comprise a testing unit to test the changes in the particles, or to adjust the optical field L89 according to the particles' characters.

The micro flow structure 310 comprises diffraction optical elements 315 and 315′. The optical tweezer 800 may further comprise two light sources in the flow path 313 at the same time to form two optical fields. The optical tweezer 800 can adjust the paths of the incident lights when used with different optical elements. The optical tweezer 800 with one light source 810, when used with the micro flow structure 310, can form two optical fields with different shapes after the incident lights pass through the diffraction optical elements 315 and 315′.

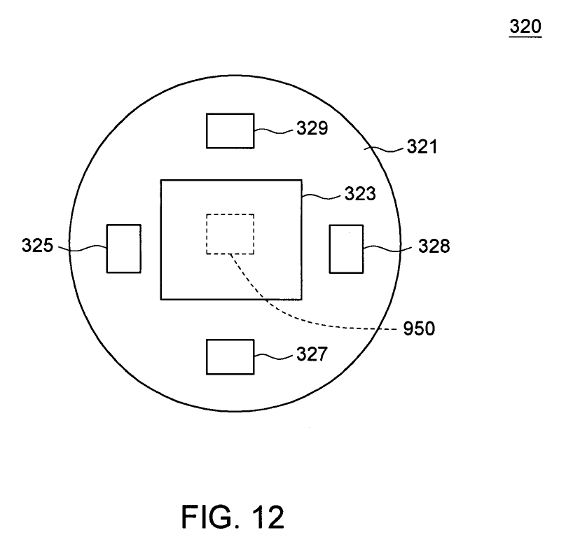

Referring to FIG. 12, FIG. 12 depicts the top view of a micro flow structure having four diffraction optical elements. The micro flow structure 320 comprises a substrate 321 and a diffraction part. The substrate 321 comprises a flow path 232 and the diffraction part comprises diffraction optical elements 325, 327, 328, and 329. The diffraction optical elements 325, 327, 328, and 329 can be on the substrate 321 at the same or different heights. Having multiple diffraction optical elements 325, 327, 328, and 329, an incident light is able to form optical fields with different characters in the same optical field zone 950. Also, when passing through the diffraction optical elements 325, 327, 328, and 329, multiple incident lights are able to form optical fields with different characters in the optical field zone 950.

The micro flow structure 320 made of optical disc can be placed on a platform (not shown) and rotate with the platform. When only one of the diffraction optical elements 325, 327, 328, and 329 is needed, the platform is rotated to adjust the positions of the diffraction optical elements 325, 327, 328, and 329. The micro flow structure 320 here has four diffraction optical elements 325, 327, 328, and 329 located at an equal distance apart; however, in another embodiment, the number of diffraction optical elements may vary for different needs.

The micro flow structure and the optical tweezer using the same in the current embodiment comprises multiple object lenses and multiple reflection mirrors for adjusting the incident lights from the light sources to form optical fields in the micro flow structure. Also, the diffraction optical element may further comprise a testing unit for testing the movement and changes of the particles and the micro flow structure may comprise multiple diffraction optical elements so the incident lights may form optical fields with different characters in the flow path. This removes the need for changing different diffraction optical elements to form optical fields with different characters in the prior art optical tweezers.

The material used in the substrate and the base of the embodiments may be polycarbonate (PC), polystyrene (PS), poly methyl methacrylate (PMMA), polyethylene terephthalate (PET), Cycloolefin copolymer (COC), or triacetyl cellulose (TAC). The base can be a glass pate when the purpose of the base is only for attaching to the substrate (such as bases 117, 127, 229, and 237). Also, the base can be a silicon base if the path of light beams does not pass through the base (such as bases 117, 127, 229, and 237).

The micro flow structure and the optical tweezer using the same in accordance with the embodiment of the present invention, the diffractive micro flow structure can be manufactured using optical disc manufacturing processes, and can be applied using biochips or optical discs. The micro flow structure combined with the optical tweezer, along with the light sources, object lens assembly, the reflection assembly, and the testing unit, control the particles by forming the optical field in the optical field zone in the flow path.

Any person with ordinary skill in the art knows that light beams can change its path and form an optical field in the flow path of the micro flow structure by having different light sources, object lens assembly, reflection mirror assembly, and other elements. The design of the flow path of the top view of the micro flow structure is not limited to the embodiment above.

While the invention has been described with reference to exemplary embodiments, it is to be understood by those skilled in the art that various changes may be made and equivalents substituted for elements thereof without departing from the scope of the invention. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A diffraction micro flow structure, comprising:
a substrate, having at least a flow path; and
a diffraction part placed on the substrate, the diffraction part having a first diffraction optical element, a first light is focused in the flow path to form a first optical field after passing through the first diffraction optical element.

2. The diffraction micro flow structure of claim 1, wherein the first diffraction optical element is placed in the flow path.

3. The diffraction micro flow structure of claim 2, wherein the diffraction part further comprises a second diffraction optical element, the second diffraction optical element is placed on the flow path, wherein a second optical field is formed in the flow path after a second light passes through the second diffraction optical element.

4. The diffraction micro flow structure of claim 3, wherein the second optical field and the first optical field are formed in different locations within the flow path.

5. The diffraction micro flow structure of claim 3, wherein the first diffraction optical element and the second diffraction optical element are placed next to each other on the same surface of the substrate.

6. The diffraction micro flow structure of claim 2, the diffraction further comprising a second diffraction optical element, and the flow path is located in between the first diffraction optical element and the second diffraction optical element; wherein a second optical field is formed in the flow path after a second light passes through the second diffraction optical element.

7. The diffraction micro flow structure of claim 1, wherein the first diffraction optical element and the flow path are located next to each other on the substrate.

8. The diffraction micro flow structure of claim 7, wherein the first diffraction optical element is a reflective diffraction optical element.

9. The diffraction micro flow structure of claim 7, wherein the diffraction part further comprises a second diffraction optical element, the second diffraction optical element and the flow path are located next to each other on the substrate, and the second diffraction optical element and the first diffraction optical element are located on opposite sides of the flow path.

10. The diffraction micro flow structure of claim 7, further comprising a reflection part, the reflection part having a first reflective layer located on one side of the first diffraction optical element, wherein the first light forms a first reflected light via the first reflective layer, and the first reflected light forms the first optical field in the flow path after passing through the first diffraction optical element.

11. The diffraction micro flow structure of claim 1, further comprising a base plate attached to the substrate for holding a solution.

12. An optical tweezer, comprising:
a light source, for outputting a first light;
a micro flow structure, comprising:
a substrate, having at least one flow path; and
a diffraction part, placed on the substrate, the diffraction part having a first diffraction optical element; and
an object lens assembly, having a first object lens, a first focus surface of the first object lens is in the flow path;
wherein the first light is focused on the first focus surface to form a first optical field after passing through the first diffraction optical element and the first object lens.

13. The optical tweezer of claim 12, wherein the first diffraction optical element is placed in the flow path.

14. The optical tweezer of claim 13, wherein the diffraction part further comprises a second diffraction optical element placed in the flow path, and the object lens assembly further comprises a second object lens having a second focus surface in the flow path, and the light source outputs a second light; wherein the second light is focused on the second focus surface to form a second optical field after passing through the second diffraction optical element and the second object lens.

15. The optical tweezer of claim 14, wherein the first focus surface and the second focus surface are located in different locations of the flow path.

16. The optical tweezer of claim 14, wherein the first diffraction optical element and the second diffraction optical element are located next to each other on a surface of the substrate.

17. The optical tweezer of claim 13, wherein the diffraction part further comprises a second diffraction optical element, the flow path is located in between the second diffraction optical element and the first diffraction optical element, and the object lens assembly further comprises a second object lens having a second focus surface in the flow path, and the light source outputs a second light, wherein the second light forms a second optical field after passing through the second diffraction optical element and the second object lens.

18. The optical tweezer of claim 17, wherein the first focus surface and the second focus surface are located in different locations within the flow path.

19. The optical tweezer of claim 12, wherein the first diffraction optical element and the flow path are located next to each other on the substrate.

20. The optical tweezer of claim 19, wherein the first diffraction optical element is a reflective diffraction optical element.

21. The optical tweezer of claim 19, wherein the diffraction part further comprises a second diffraction optical element, the second diffraction optical element and the flow path are located next to each other on the substrate, and the second diffraction optical element and the first diffraction optical element are located on opposite sides of the substrate.

22. The optical tweezer of claim 19, wherein the micro flow structure further comprises a reflection part having a first reflective layer located on one side of the first diffraction optical element, wherein the first light forms a first reflected light via the first reflective layer, and the first reflected light forms the first optical field in the flow path after passing through the first diffraction optical element.

23. The optical tweezer of claim 22, wherein the reflection part further comprises a second reflective layer located on another side of the first diffraction optical element, wherein after passing through the first diffraction optical element, the first reflected light is reflected to the flow path for forming the first optical field by the second reflective layer.

24. The optical tweezer of claim 12, further comprising a reflection assembly having at least a first reflection mirror located on a side of the micro flow structure, wherein the first light forms first reflected light via the first reflection mirror, and the first reflected light forms the first optical field in the flow path after passing through the first diffraction optical element.

25. The optical tweezer of claim 12, wherein the micro flow structure holds at least one particle, and the optical tweezer further comprises a testing unit located next to the micro flow structure for testing the particle.
